(19) United States
(12) Patent Application Publication
(10) Pub. No.: US 2009/0263543 A1
(43) Pub. Date: Oct. 22, 2009

(54) Method for Producing Solid Enzyme Granulates for Animal Food

(75) Inventors: Markus Lohscheidt, Heidelberg (DE); Roland Betz, Niederkirchen (DE); Jorg Braun, Essingen (DE); Wolf Pelletier, Ottersheim (DE); Andreas Habich, Speyer (DE); Peter Ader, Heppenheim (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 11/991,835

(22) PCT Filed: Sep. 11, 2006
(86) PCT No.: PCT/EP2006/066216

§ 371 Date: Mar. 11, 2008

(30) Foreign Application Priority Data
Sep. 12, 2005 (DE) 102005043327.8

(51) Int. Cl. A23K 1/165; A23P 1/12

(52) U.S. Cl. 426/61; 426/516

(57) ABSTRACT

The present invention relates to novel methods for producing coated granulated enzyme-comprising feed additives, to the coated enzyme-comprising granules produced in this manner, and also to feed compositions which are obtainable using the coated granules. This method comprises the following steps:
a) Extrusion of an enzyme-comprising dough which, in addition to water, comprises
   i) 50 to 96.9% by weight of at least one solid carrier material suitable for feed,
   ii) 0.1 to 20% by weight of at least one water-soluble polymer,
   iii) 3 to 49.9% by weight of at least one enzyme, the weight fractions of i), ii) and iii) in each case being based on the nonaqueous components of the dough;
b) final-processing the extrudate to give raw granules having a water content of no greater than 15% by weight, and
c) coating the raw granules with a hydrophobic material selected in an extent of at least 70% by weight, based on the hydrophobic material, from saturated fatty acids, the esters of saturated fatty acids, in particular the mono-, di- and triglycerides of saturated fatty acids, and mixtures thereof.

The present invention relates to novel methods for producing coated granulated, enzyme-comprising feed additives, the coated, enzyme-comprising granules produced in this manner, and also feed compositions which are obtainable using the coated granules.

It is generally customary to add enzymes to animal feed in order to ensure better feed utilization, better product quality or lower pollution of the environment. In addition, it is current practice to supply animal feeds in pelleted form, since pelleting not only facilitates feed intake, but also improves handling of the feedstuff. In addition, it has been found that in the case of pelleted feedstuff, certain feed components are digested better, and ingredients added to the feedstuff such as, for example, vitamins, enzymes, trace elements, can be better incorporated in the feed mixture.

To reduce the microbial loading (sanitation) of such animal feeds, heat treating is frequently carried out. A heat treatment also proceeds in the context of the conditioning required for pelleting, in which the feedstuff is admixed with steam and thereby heated and moistened. In the actual pelleting step, the feedstuff is forced through a matrix. Other processes used in the feed industry are extrusion and expansion. The action of heat in all of these processes is in particular a problem, when enzymes, which are generally thermally unstable, are present in the feed mixture. Therefore, various efforts have been made to improve the thermal stability and, in particular, the pelleting stability of enzyme-comprising feed compositions.

EP-A-0 257 996 proposes, for example, stabilizing enzymes for feed mixtures by pelleting them in a mixture with a carrier which has a main fraction of cereal flour.

WO 98/54980 in turn describes enzyme-comprising granules having improved pelleting stability which are produced by extruding an aqueous enzyme solution with a carrier based on an edible carbohydrate, and subsequent drying.

WO 92/12645 proposes incorporating feed enzymes into what is termed T granules. These T granules comprise a fraction of 2 to 40% by weight of cellulose fibers. These special granules are then coated in a specific manner. The coating comprises a high fraction, preferably about 60 to 65% by weight, of an inorganic filler, such as, for example, kaolin, magnesium silicate or calcium carbonate. As follows from the examples of WO 92/12645, a single-stage application of the coating is not possible. Rather, a high-melting fat or wax and the filler must be applied alternately in a plurality of steps to the T granules. The disadvantages of the solution route proposed in this prior art for improving pelleting stability are evident. Firstly, a highly specific carrier material is absolutely necessary, secondly a complex multistage coating of the carrier material is necessary.

WO 01/00042 again teaches polymer-coated enzyme granules. The use of fats for coating is described as disadvantageous.

WO 03/059086 again teaches a method for producing enzyme granules of improved pelleting stability, in which enzyme-comprising raw granules are coated with an aqueous dispersion of a hydrophobic substance. In the case of fat dispersions, this method does not give satisfactory pelleting stabilities.

It is therefore an object of the present invention to provide a method for producing enzyme-comprising feed additives with improved pelleting stability.

It has surprisingly been found that by means of the method described in more detail hereinafter enzyme granules of particularly high pelleting stability are obtained. This method comprises the following steps:

a) Extrusion of an enzyme-comprising dough which, in addition to water, comprises
i) 50 to 96.9% by weight of at least one solid carrier material suitable for feed,
ii) 0.1 to 20% by weight of at least one water-soluble polymer,
iii) 3 to 49.9% by weight of at least one enzyme, the weight fractions of i), ii) and iii) in each case being based on the nonaqueous components of the dough;
   b) final-processing the extrudate to give raw granules having a water content of no greater than 15% by weight, and
   c) coating the raw granules with a hydrophobic material, selected to an extent of at least 70% by weight, based on the hydrophobic material, from saturated fatty acids, the esters of saturated fatty acids, in particular the monoglycerides, diglycerides and triglycerides of saturated fatty acids and mixtures thereof.

Correspondingly, the invention relates to such a method and the enzyme granules obtainable by this method and also to feed compositions, in particular hydrothermally treated feed compositions, and especially feed compositions in pelleted form which comprise such enzyme granules.

According to the invention, producing the crude granules comprises, in a first step, extrusion of a water-comprising dough which comprises at least one carrier material suitable for feeds.

As feed-compatible carrier materials, use can be made of customary inert inorganic or organic carriers. An “inert” carrier must not exhibit any adverse interactions with the enzyme(s) of the inventive feed additive, such as, for example, cause irreversible inhibition of the enzyme activity, and must be harmless for use as an auxiliary in feed additives. Examples of suitable carrier materials which may be mentioned are: low-molecular-weight organic compounds, and also higher-molecular-weight organic compounds of natural or synthetic origin, and also inert inorganic salts. Preference is given to organic carrier materials. Among these, carbohydrates are particularly preferred.

Examples of suitable low-molecular-weight organic carriers are, in particular, sugars such as, for example, glucose, fructose, sucrose. Examples of higher-molecular-weight organic carriers which may be mentioned are carbohydrate polymers, in particular those which comprise α-D-glucopyranose, amylose or amylopectin units, in particular native and modified starches, microcrystalline cellulose, but also α-glucans and β-glucans, pectin (including protopectin) and glycogen. Preferably, the carrier material comprises at least one water-insoluble polymeric carbohydrate, in particular a native starch material such as, in particular, corn starch, rice starch, wheat starch, potato starch, starches of other plant sources such as starch from tapioca, cassava, sago, rye, oats, barley, sweet potatoes, arrowroot and the like, in addition cereal flours such as, for example, corn flour, wheat flour, rye flour, barley flour and oat flour, and also rice flour. Suitable materials are, in particular, also mixtures of the abovementioned carrier materials, in particular mixtures which predominantly, i.e. at least 50% by weight, based on the carrier material, comprise one or more starch materials. Preferably, the water-insoluble carbohydrate makes up at least 50% by weight, in particular at least 65% by weight, and especially at least 80% by weight, of the carrier material. Particularly preferred carrier materials are starches which comprise no more than 5% by weight, and in particular no more than 2% by weight, of protein or other components. A further preferred carrier material is microcrystalline cellulose. This can be used alone or in a mixture with the abovementioned carrier materials. If the microcrystalline cellulose is used in a mixture with other carrier materials, it preferably makes up no more than 50% by weight, in particular no more than 30% by weight, for example 1 to 50% by weight, in particular 1 to 30% by weight, and especially 1 to 10% by weight, of the carrier material.

Inorganic carrier materials which come into consideration are in principle all inorganic carrier materials known for feeds and feed additives, for example inert inorganic salts, for example sulfates or carbonates of alkali and alkaline earth metals such as sodium, magnesium, calcium and potassium sulfate or carbonate, in addition feed-compatible silicates such as talcum and silicic acids. The amount of inorganic carrier material, based on the total amount of carrier material, will generally not exceed 50% by weight, particularly 35% by weight, and very particularly 20% by weight. In a preferred embodiment, the organic carrier materials make up the total amount or virtually the total amount, that is at least 80% by weight, of the carrier material.

The carrier material generally makes up 50 to 96.9% by weight, frequently 55 to 94.5% by weight, and in particular 60 to 90% by weight, of the nonaqueous components of the dough and is correspondingly present in the inventive enzyme granules in these amounts.

In addition to feed-compatible carrier material, the dough to be extruded comprises according to the invention at least one water-soluble polymer. This polymer acts as binder and at the same time increases the pelleting stability. Preferred water-soluble polymers exhibit a number-average molecular weight in the range from 5×10³ to 5×10⁶ dalton, in particular in the range from 1×10⁴ to 1×10⁶ dalton. The polymers are water-soluble when at least 3 g of polymer may be dissolved completely in 1 liter of water at 20° C.

The water-soluble polymers used according to the invention comprise
polysaccharides, for example water-soluble modified starches generally having adhesive properties, for example starch breakdown products (dextrins) such as acid dextrins, pyrodextrins, enzymatic partial hydrolyzates (limited dextrins), oxidatively broken down starches and their reaction products of dextrins with cationic or anionic polymers, reaction products of dextrins with octenyl succinate anhydride (OSA), starch-based adhesive, in addition chitin, chitosan, carragheen, alginates, arabic acid salts, gums, e.g. gum Arabic, tragacanth, karaya gum; xanthan gum and gellan gum; galactomannans; water-soluble cellulose derivatives, for example methylcellulose, ethylcellulose and hydroxyalkylcelluloses such as, for example, hydroxyethylcellulose (HEC), hydroxyethyl methylcellulose (HEMC), ethyl hydroxyethylcellulose (EHEC), hydroxypropylcellulose (HPC), hydroxypropyl methylcellulose (HPMC) and hydroxybutylcellulose, and also carboxymethylcellulose (CMC);
water-soluble proteins, e.g. proteins of animal origin such as gelatin, casein, in particular sodium caseinate and plant proteins such as soy protein, pea protein, bean protein, rapeseed protein, sunflower protein, cottonseed protein, potato protein, lupin, zein, wheat protein, corn protein and rice protein,
synthetic polymers, for example polyethylene glycol, polyvinyl alcohol and, in particular, the kollidon brands of BASF, vinyl alcohol/vinyl ester copolymers, homo- and copolymers of vinylpyrrolidone with vinyl acetate and/or C₁-C₄-alkyl acrylates,
and biopolymers modified if appropriate, e.g. lignin or polylactide.

Preferred water-soluble polymers are neutral, that is they have no acidic or basic groups. Among these, polyvinyl alcohols, including partially saponified polyvinyl acetates having a degree of saponification of at least 80%, and also, in particular, water-soluble, neutral cellulose ethers such as methylcellulose, ethylcellulose and hydroxyalkylcelluloses such as, for example, hydroxyethylcellulose (HEC), hydroxyethyl methylcellulose (HEMC), ethyl hydroxyethylcellulose (EHEC), hydroxypropylcellulose (HPC), hydroxypropyl methylcellulose (HPMC) and hydroxybutylcellulose are particularly preferred.

In a preferred embodiment of the invention, the water-soluble polymer is selected from neutral cellulose ethers. Examples of inventively preferred water-soluble neutral cellulose ethers are methylcellulose, ethylcellulose and hydroxyalkylcelluloses, for example hydroxyethylcellulose (HEC), hydroxyethyl methylcellulose (HEMC), ethyl hydroxyethylcellulose (EHEC), hydroxypropylcellulose (HPC), hydroxypropyl methylcellulose (HPMC) and hydroxybutylcellulose. Among these, methylcellulose, ethylcellulose and mixed cellulose ethers having methyl groups or ethyl groups and hydroxyalkyl groups such as HEMC, EHEC and HPMC are particularly preferred. Preferred methyl- or ethyl-substituted cellulose ethers have a degree of substitution DS (with respect to the alkyl groups) in the range from 0.8 to 2.2 and, in the case of mixed cellulose ethers, a degree of substitution DS with respect to the alkyl groups in the range from 0.5 to 2.0, and a degree of substitution HS with respect to the hydroxyalkyl groups in the range from 0.02 to 1.0.

The fraction of water-soluble polymers is preferably in the range from 0.2 to 10% by weight, in particular 0.3 to 5% by weight, and especially 0.5 to 3% by weight, based on the dough-forming nonaqueous components and is accordingly in these amounts a component of the enzyme-comprising raw granules.

In addition, the dough comprises at least one enzyme, mixtures of different enzymes also being able to be present. Typical enzymes for feeds are for example oxidoreductases, transferases, lyases, isomerases, ligases, lipases, and hydrolases.

Examples of hydrolases, that is enzymes which cause a hydrolytic cleavage of chemical bonds, are esterases, glycosidases, ether hydrolases, proteases, amidases, aminidases, nitrilases, and phosphatases. Glycosidases (EC 3.2.1, also termed carbohydrases) comprise not only endo- but also exoglycosidases, which cleave not only α- but also β-glycosidic bonds. Typical examples thereof are amylases, maltases, keratinases, cellulases, endoxylanases, for example endo-1,4-β-xylanase or xylan endo-1,3-β-xylosidase, β-glucanases, in particular endo-1,4-β- and endo-1,3-β-glucanases, mannanases, lysozymes, galactosidases, pectinases, β-glucuronidases and the like. The inventive method is suitable, in particular, for producing pelleting-stable enzyme granules which are selected from enzymes cleaving nonstarch polysaccharides such as, for example, glucanases and xylanases, and also in particular from phosphatases (EC 3.1.3) and especially phytases (EC 3.1.3.8, 3.1.3.26 and 3.1.3.72).

The expression “phytase” comprises not only natural phytase enzymes, but also any other enzyme which exhibits phytase activity, for example is capable of catalyzing a reaction which liberates the phosphorus or phosphate from myoinositol phosphates. The phytase can be not only a 3-phytase (EC 3.1.3.8) but also a 4- or 6-phytase (EC 3.1.3.26) or a 5-phytase (EC 3.1.3.72) or a mixture thereof. Preferably, the phytase belongs to the enzyme class EC 3.1.3.8.

The phytase preferably used in the method according to the invention is not subject to any restrictions and can be not only of microbiological origin, but also a phytase obtained by genetic modification of a naturally occurring phytase, or by de-novo construction. The phytase can be a phytase from plants, from fungi, from bacteria, or a phytase produced by yeasts. Preference is given to phytases from microbiological sources such as bacteria, yeasts or fungi. However, they can also be of plant origin. In a preferred embodiment, the phytase is a phytase from a fungal strain, in particular from an Aspergillus strain, for example Aspergillus niger, Aspergillus oryzae, Aspergillus ficuum, Aspergillus awamori, Aspergillus fumigatus, Aspergillus nidulans or Aspergillus terreus. Particular preference is given to phytases which are derived from a strain of Aspergillus niger or a strain of Aspergillus oryzae. In another preferred embodiment, the phytase is derived from a bacterial strain, in particular a Bacillus strain, an E. coli strain or a Pseudomonas strain, among these phytases being preferred which are derived from a Bacillus subtilis strain. In another preferred embodiment, the phytase is derived from a yeast, in particular a Kluveromyces strain or a Saccharomyces strain, among these phytases being preferred which are derived from a strain of Saccharomyces cerevisiae. In this invention, the expression “an enzyme derived from . . . ” comprises the enzyme naturally produced by the respective strain which is either obtained from the strain, or that is coded for by a DNA sequence isolated from the strain and is produced by a host organism which has been transformed using this DNA sequence. The phytase can be obtained from the respective microorganism by known techniques which typically comprise fermentation of the phytase-producing microorganism in a suitable nutrient medium (see, for example, ATCC catalog) and subsequently obtaining the phytase from the fermentation medium by standard techniques. Examples of phytases and of methods for preparing and isolating phytases may be found in EP-A 420358, EP-A 684313, EP-A 897010, EP-A 897985, EP-A 10420358, WO 94/03072, WO 98/54980, WO 98/55599, WO 99/49022, WO 00/43503, WO 03/102174, the contents of which are hereby explicitly incorporated by reference.

The amount of enzyme in the dough obviously depends on the desired activity of the enzyme granules and the activity of the enzyme used and is typically in the range from 3 to 49.9% by weight, frequently in the range from 5 to 49.7% by weight, in particular in the range from 10 to 45% by weight, and especially in the range from 10 to 39% by weight, calculated as dry mass and based on the total weight of all nonaqueous components of the dough.

In addition, the dough used in step a) can additionally comprise a salt stabilizing the enzyme. Stabilizing salts are typically salts of divalent cations, in particular salts of calcium, magnesium or zinc, and also salts of monovalent cations, in particular sodium or potassium, for example the sulfates, carbonates, hydrogencarbonates and phosphates including hydrogenphosphates and ammonium hydrogenphosphates of these metals. Preferred salts are sulfates. Particular preference is given to magnesium sulfate and zinc sulfate, including their hydrates. The amount of salt is preferably in the range from 0.1 to 10% by weight, in particular in the range from 0.2 to 5% by weight, and especially in the range from 0.3 to 3% by weight, based on the total weight of all nonaqueous components of the dough.

In addition to aforesaid components, the dough comprises water in an amount which ensures sufficient homogenization for the dough-forming components and adequate consistency (plasticization) of the dough for extrusion. The amount of water required for this can be determined in a manner known per se by those skilled in the art in the field of enzyme formulation. The water fraction in the dough is typically in the range from >15 to 50% by weight, in particular in the range from 20 to 45% by weight, and especially in the range from 25 to 40% by weight, based on the total weight of the dough.

In addition, the dough can comprise further components in a minor amount which generally make up no more than 10% by weight of the dough, for example agents for setting the pH such as buffers (phosphate buffer, potassium or sodium phosphate, their hydrates or dihydrates, sodium or potassium carbonate), bases (sodium, potassium, calcium, magnesium or ammonium hydroxide, ammonia water) or acids (inorganic or organic acids, hydrochloric acid, sulfuric acid, phosphoric acid, citric acid, acetic acid, formic acid, propionic acid). Further fillers can also be added to the dough which fillers beneficially affect the properties of the dough, such as, for example, flow behavior or adhesion behavior. These include substances such as salts (inorganic salts, sulfates or carbonates of the alkali and alkaline earth metals, sodium, magnesium, calcium, potassium or zinc salts), sugars (glucose, fructose, sucrose, dextrins), or else talcum, microcrystalline cellulose and silicic acids.

The dough is produced in a manner known per se by mixing the dough-forming components in a suitable mixing apparatus, for example in a conventional mixer or kneader. For this, the solid or solids, for example the carrier material, are intensively mixed with the liquid phase, for example water, an aqueous binder solution or an aqueous enzyme concentrate. Generally, the carrier will be introduced as solid into the mixer and mixed with an aqueous enzyme concentrate and also with the water-soluble polymer, preferably in the form of a separate aqueous solution or dissolved in the aqueous enzyme concentrate, and also if appropriate with the stabilizing salt, preferably in the form of a separate aqueous solution or suspension, in particular dissolved or suspended in the aqueous enzyme concentrate. If appropriate, further water will be added to set the desired consistency of the dough. Preferably, during mixing, a temperature of 60° C., in particular 40° C., will not be exceeded. Particularly preferably, the temperature of the dough during mixing is 10 to 30° C. If appropriate, therefore, the mixing apparatus will be cooled during thorough mixing.

Additionally it has proven useful to control the pH of the aqueous phase before or during dough production. According to a preferred embodiment of the invention, therefore, a pH is set in the range from 3.5 to 7, in particular in the range from 4 to 6, and especially in the range from 4.5 to 5.5. Setting the pH likewise surprisingly leads to enhanced stability of the enzyme granules, in particular when the enzyme is a hydrolase, and especially a phosphatase. To set the pH, use can be made of, for example, an acid or base, or a buffer. Preferably, a selection will be made from agents for setting the pH which are permitted in feeds. The agent for setting the pH can be added both to the dough as such, or, together with one of the abovementioned components of the dough, preferably in the form of an aqueous solution. In particular, the agent for setting the pH is added dissolved in the enzyme concentrate. Correspondingly, the pH of the enzyme concentrate is set in accordance with the abovementioned ranges preferably before mixing. The agent for setting the pH obviously depends on the pH which is established by mixing the components. Since the enzyme concentrate frequently has a weakly acidic pH below 4, preferably a buffer or a base will be added. Suitable bases are, in addition to ammonia, ammonia water and ammonium hydroxide, alkalimetal and alkaline earth metal salts such as, for example, sodium, potassium, magnesium and calcium hydroxides, citrates, acetates, formates, hydrogenformates, carbonates and hydrogen carbonates, and also amines and alkaline earth metal oxides such as CaO and MgO. Examples of inorganic buffering agents are alkalimetal hydrogenphosphates, in particular sodium and potassium hydrogenphosphates, for example K₂HPO₄, KH₂PO₄ and Na₂HPO₄.

A preferred agent for setting the pH is ammonia or ammonia water, or sulfuric acid. Suitable buffers are, for example, mixtures of the abovementioned bases with organic acids such as acetic acid, formic acid, citric acid.

The resultant dough is subsequently subjected to an extrusion, preferably an extrusion at low pressure. The extrusion, in particular extrusion at low pressure, generally proceeds in an apparatus in which the mix (dough) to be extruded is forced through a matrix. The hole diameter of the matrix determines the particle diameter and is generally in the range from 0.3 to 2 mm, and in particular in the range from 0.4 to 1.0 mm. Suitable extruders are, for example, dome extruders or basket extruders which, inter alia, are marketed by companies such as Fitzpatrick or Bepex. For correct consistency of the mix to be granulated, in this case only a low temperature increase results on passing through the matrix (up to approximately 20° C.). Preferably, the extrusion proceeds under temperature control, that is the temperature of the dough should not exceed a temperature of 70° C., in particular 60° C., during extrusion. In particular, the temperature of the dough during extrusion is in the range from 20 to 50° C.

The extruded dough strands leaving the extruder break up into short granule-like particles or can be broken if appropriate using suitable cutting apparatuses. The resultant granule particles typically have a homogeneous particle size, that is a narrow particle size distribution.

In this manner raw granules are obtained having a comparatively high water content which is generally greater than 15% by weight, for example in the range from 15 to 50% by weight, in particular in the range from 20 to 45% by weight, based on the total weight of the moist raw granules. According to the invention, therefore, before coating, processing is carried out in such a manner that the water content of the raw granules is no greater than 15% by weight and preferably is in the range from 1 to 12% by weight, in particular in the range from 3 to 10% by weight, and especially in the range from 5 to 9% by weight.

The final processing therefore generally comprises a drying step. This preferably proceeds in a fluidized-bed dryer. In this case, a heated gas, generally air or a nitrogen gas stream, is passed from below through the product layer. The gas rate is customarily set so that the particles are fluidized and swirl. As a result of the gas/particles heat transfer, the water evaporates. Since enzyme-comprising raw granules are generally heat-labile, it is necessary to ensure that the temperature of the raw granules does not rise too high, that is generally not above 80° C., and preferably not above 70° C. In particular, the temperature of the granules during drying is in the range from 30 to 70° C. The drying temperature can be controlled in a simple manner via the temperature of the gas stream. The temperature of the gas stream is typically in the range from 140 to 40° C., and in particular in the range from 120 to 60° C. Drying can proceed continuously or batchwise.

After drying, the granules can be further fractionated by means of a sieve (optional). Coarse material and fines can be ground and returned to the mixer for preparing the extrusion dough of the granulation mix.

In addition, it has proved to be advantageous to round, that is to say spheronize, the still-moist raw granules before carrying out drying. In this case, in particular, the formation of unwanted dust fractions in the end product is decreased.

Apparatuses suitable for rounding the moist raw granules are what are termed spheronizers which essentially have a horizontally rotating disk on which the small extruded rods are forced to the wall by the centrifugal force. The small extruded rods break up on the micronotches prefixed by the extrusion process, so that cylindrical particles are formed having a ratio of diameter to length of about 1:1.3 to 1:3. As a result of the mechanical loading in the spheronizer, the initially cylindrical particles are somewhat rounded.

The raw granules obtained after final processing advantageously have a median particle size in the range from 100 to 2000 μm, in particular in the range from 200 to 1500 μm, and especially in the range from 300 to 1000 μm. The median particle size distribution can be determined in a manner known per se by light scattering, for example using a Mastersizer S from Malvern Instruments GmbH or by sieve analysis, for example using a Vibro VS 10000 sieving machine from Retsch. The median particle size is taken by those skilled in the art to mean the D₅₀ value of the particle size distribution curve, that is to say the value which 50% by weight of all particles fall above or below. Preference is given to raw granules having a narrow particle size distribution.

Subsequently, the resultant granules are provided with a hydrophobic coating. According to the invention, the material forming the coating at least 70% by weight, particularly at least 80% by weight, in particular at least 90% by weight, comprises saturated fatty acids, fatty acid esters, or their mixtures.

Saturated means that the hydrophobic material is essentially free from unsaturated components and correspondingly has an iodine value less than 5, and in particular less than 2 (method according to Wijs, DIN 53 241).

Esters of fatty acids are, in particular, the mono-, di- and triglycerides of saturated fatty acids, and also esters of fatty acids with saturated fatty alcohols having, for example, 10 to 32 carbon atoms, in particular having 16 to 24 carbon atoms, such as cetyl alcohol, or stearyl alcohol.

The fatty acids or the fatty acid radicals in the esters of fatty acids preferably have 10 to 32 carbon atoms, frequently 12 to 24 carbon atoms, and in particular 16 to 22 carbon atoms. Preference is given to hydrophobic materials having melting points in the range from 40 to 95° C., particularly in the range from 45 to 80° C., in particular in the range from 50 to 70° C.

Preferably, the hydrophobic material is low-acidity material, and has an acid value less than 80, in particular less than 30, and especially less than 10 (determined as defined in ISO 660). In particular preferably, the hydrophobic material comprises at least 70% by weight, in particular at least 80% by weight, and especially at least 90% by weight, of the abovementioned triglycerides.

In a preferred embodiment of the invention, the coating agent predominantly, that is up to at least 70% by weight, in particular at least 80% by weight, and especially greater than 90% by weight, comprises hydrogenated vegetable oils, including triglycerides, for example hydrogenated cottonseed, corn, peanut, soybean, palm, palm kernel, babassu, rapeseed, sunflower and safflower oils. Hydrogenated vegetable oils which are particularly preferred among these are hydrogenated palm oil, cottonseed oil and soybean oil. The most preferred hydrogenated vegetable oil is hydrogenated soybean oil. Similarly, other fats and waxes originating from plants and animals are also suitable, for example beef tallow. Suitable materials are also nature-identical fats and waxes, that is synthetic waxes and fats having a composition which predominantly corresponds to that of the natural products.

The table below mentions some examples of coating materials which are suitable according to the invention.

| | | Melting | |
|---|---|---|---|
| Name | Composition | range | CAS No./INCI |
| Cutina CP from | synthetic cetyl palmitate | 46-51° C. | 95912-87-1 |
| Cognis | | | cetyl palmitate |
| Edenor NHTI-G from | Triglyceride | 56-60° C. | 67701-27-3* |
| Cognis | | | |
| Edenor NHTI-V from | Triglyceride | 57-60° C. | 67701-27-3* |
| Cognis | | | EINECS 266-945-8 |
| Edenor C1892 from | Stearic acid, C16-18 | 66-99° C. | |
| Cognis | | | |
| Edenor HPA from | Fatty acids, palm oil, | 55-57° C. | |
| Cognis | hydrogenated, | | |
| | C16-18 | | |
| Edenor HRAGW from | Fatty acids, C16-22 | 64-66° C. | |
| Cognis | | | |
| Edenor C2285R from | Fatty acids, C18-22 | 75-78° C. | 68002-88-0* |
| Cognis | | | |
| Rilanit from Cognis | Triglyceride | 83-90° C. | |
| Japan wax | principally glycerol palmitate | 49-55° C. | rhus succedanea |
| substitute from Kahl- | | | |
| Wachsraffinerie | | | |
| Tefacid from | palm kernel oil Tefacid Palmic 90 | 65° C. | 57-10-3 |
| Karlshamns | | | |
| Soybean fat powder | | 65-70° C. | |
| from Sankyu/Japan | | | |

Suitable products are also those of the company Aarhus Olie, Denmark, marketed under the trademark Vegeol PR, for example Vegeol® PR 267, PR 272, PR 273, PR 274, PR 275, PR 276, PR 277, PR 278 and PR 279.

The amount of hydrophobic material is generally 1 to 35% by weight, preferably 4 to 30% by weight, in particular 5 to 25% by weight, and especially 7 to 21% by weight, based on the raw granules used and dried.

The hydrophobic material can be applied in a manner known per se by application of a solution, dispersion or suspension of the hydrophobic material in a suitable solvent, for example water, or by application of a melt of the hydrophobic material. The application of a melt is preferred according to the invention, because the subsequent removal of solvent or dispersion medium can thereby be avoided. This means that for application of a melt, the use of an expensive dryer/coater (for example a fluidized-bed dryer) is not required, but the use of a mixer is possible. Coating with a melt of the hydrophobic material is also termed hereinafter melt coating.

Suitable methods for applying the coating comprise coating in a fluidized bed, and also coating in a mixer (continuously or batchwise), for example a granulation drum, a ploughshare mixer, for example from Lödige, a paddle mixer, for example from Forberg, a Nauta mixer, a granulating mixer, a granulating dryer, a vacuum coater, for example from Forberg, or a high-shear granulator.

In particular, the raw granules are coated
i) in a fluidized bed, for example by spraying the raw granules with a melt, a solution or dispersion of the hydrophobic material; and also
ii) in one of the abovementioned mixing apparatuses by introduction of the raw granules into a melt of the hydrophobic material or by spraying or pouring a melt, a solution or dispersion of the hydrophobic material onto the raw granules.

Coating the raw granules by spraying with a melt, a solution or dispersion in a fluidized bed is particularly preferred according to the invention. Spraying the raw granules with a melt, a solution or dispersion of the hydrophobic material can be carried out in the fluidized-bed apparatus in principle in the bottom-spray method (nozzle is seated in the gas-distribution plate and sprays upwards) or in the top-spray method (coating is sprayed into the fluidized bed from the top).

The raw granules can be coated in the context of the inventive method continuously or batchwise.

According to a first preferred embodiment of the inventive method, the raw granules are charged into a fluidized bed, swirled and, by spraying on an aqueous or nonaqueous, preferably aqueous, dispersion of the hydrophobic material, are coated with this material. For this use is made of preferably a liquid which is as highly concentrated as possible and still sprayable, such as, for example, a 10 to 50% strength by weight aqueous dispersion or nonaqueous solution or dispersion of the hydrophobic material.

The solution or dispersion of the hydrophobic material is preferably sprayed on in such a manner that the raw granules are charged into a fluidized-bed apparatus or a mixer and sprayed onto the spray material with simultaneous heating of the charge. The energy is supplied in the fluidized-bed apparatus by contact with heated drying gas, frequently air. Preheating the solution or dispersion can be expedient when as a result spray material having a higher dry substance fraction can be sprayed. When use is made of organic liquid phases, solvent recovery is expedient and the use of nitrogen as drying gas to avoid explosive gas mixtures is preferred. The product temperature during coating should be in the range from about 30 to 80° C., and in particular in the range from 35 to 70° C., and especially in the range from 40 to 60° C. Coating can be carried out in the fluidized-bed apparatus in principle in the bottom-spray method (nozzle is seated in the gas-distribution plate and sprays upwards) or in the top-spray method (coating is sprayed into the fluidized bed from the top). When a mixer is used for coating, after the solution or dispersion is sprayed on, the solvent or the liquid must be removed from the dispersion. This can be carried out in a dryer.

According to a second, particularly preferred embodiment of the inventive method, the raw granules charged into a fluidized bed or mixer are coated with a melt of the hydrophobic material. Melt coating in a fluidized bed is preferably carried out in such a manner that the raw granules to be coated are charged into the fluidized-bed apparatus. The hydrophobic material is melted in an external reservoir and pumped, for example via a heatable line to the spraying nozzle. Heating the nozzle gas is expedient. Spraying rate and inlet temperature of the melt are preferably set in such a manner that the hydrophobic material still runs readily on the surface of the granules and evenly coats them. Preheating the granules before spraying the melt is possible. In the case of hydrophobic materials having a high melting point, generally the temperature will be selected in such a manner that a loss of enzyme activity is substantially avoided. The product temperature should therefore preferably be in the range from about 30 to 80° C., and in particular in the range from 35 to 70° C., and especially in the range from 40 to 60° C. Melt coating can also be carried out in principle by the bottom-spray method or by the top-spray method.

Melt coating can be carried out in a mixer in two different ways. Either the granules to be coated are charged into a suitable mixer and a melt of the hydrophobic material is sprayed or poured into the mixer. Another possibility is to mix the hydrophobic material present in solid form with the product. By supplying energy via the vessel wall or via the mixing tools, the hydrophobic material is melted and thus coats the raw granules. According to requirement, from time to time a little release agent can be added. Suitable release agents are, for example, silicic acid, talcum, stearates and tricalcium phosphate, or salts such as magnesium sulfate, sodium sulfate or calcium carbonate.

Other additives, such as, for example, microcrystalline cellulose, talcum and kaolin, or salts, can be added, if appropriate to the solutions, dispersions or melts used for coating.

In a particular inventive embodiment of the method, the addition of release agents during application of the hydrophobic material or the addition of release agents to the solution, dispersion or melt to be applied can be omitted. This is possible, in particular, when the enzyme cores used have median particle sizes of at least 300 μm, preferably at least 350 μm, in particular at least 400 μm, for example in the range from 250 to 1600 μm, preferably in the range from 300 μm to 1500 μm, and in particular in the range from 400 μm to 1400 μm, and simultaneously the amount of hydrophobic coating material used based on the total particle is no greater than 30% by weight, preferably no greater than 25% by weight, in particular no greater than 20% by weight, and especially no greater than 17% by weight. In these cases, enzyme cores may be coated particularly readily without agglomeration of the particles.

The addition of a flow aid after the coating step can enhance the flow properties of the product. Typical flow aids are silicic acids, for example the Sipernat products from Degussa or the Tixosil products from Rhodia, talcum, stearates and tricalcium phosphate, or salts such as magnesium sulfate, sodium sulfate or calcium carbonate. The flow aids are added to the coated product in an amount of from 0.005% by weight to 5% by weight, based on the total weight of the product. Preferred contents are 0.1% by weight to 3% by weight, and particularly preferred 0.2% by weight to 1.5% by weight.

Obviously, according to the inventive method, in addition to the coating made of hydrophobic material, one or more, for example 1, 2 or 3, further coatings can also be applied which consist of other materials, for example the polymer coatings taught in the prior art, as are disclosed, for example, by WO 01/00042, WO 03/059086 and WO 03/059087. It is essential to the invention that at least one coating comprises the above-defined hydrophobic materials, this layer being able to be arranged as desired, and in particular arranged directly on the enzyme-comprising core.

The enzyme granules obtainable by the inventive method are distinguished by a particularly high stability, in particular a high pelleting stability. Correspondingly, the present invention relates to the enzyme granules which are obtainable by the inventive method.

The granule particles of the enzyme granules obtainable according to the invention have, owing to production conditions, an enzyme-comprising core, and at least one hydrophobic coating arranged on the surface of the core, which coating comprises the above-defined hydrophobic materials. In addition, the granule particles can also have one or more, for example 1, 2 or 3, further coatings made of other materials, the coating made of the inventive hydrophobic material preferably being arranged directly on the enzyme-comprising core.

Without wishing to be restricted to one theory, it may be assumed that the particular stability of the inventively obtainable enzyme granules is based on interaction of the special composition of the enzyme core with the special hydrophobic coating.

Correspondingly, the invention relates, in particular, to enzyme granules for feeds, the particles of which
A) have an enzyme-comprising core having a water content less than 15% by weight, frequently in the range from 1 to 12% by weight, in particular in the range from 3 to 10% by weight, and especially in the range from 5 to 9% by weight, based on the weight of the enzyme-comprising core which comprises
   i) 50 to 96.9% by weight, preferably 55 to 94.5% by weight, and in particular 60 to 90% by weight, at least one of the abovementioned solid organic carrier materials,
   ii) 0.1 to 20% by weight, preferably 0.2 to 10% by weight, in particular 0.3 to 5% by weight, and especially 0.5 to 3% by weight, of at least one of the abovementioned water-soluble polymeric binders,
   iii) 3 to 49.9% by weight, in particular 5 to 49.7% by weight, and especially 10 to 40% by weight, of at least one of the abovementioned enzymes, and also
   iv) if appropriate at least one of the abovementioned stabilizing salts in an amount of preferably up to 10% by weight, for example 0.1 to 10% by weight, in particular 0.2 to 5% by weight, and especially 0.3 to 3% by weight,
   the weight fractions of i), ii) and iii) and also, if appropriate iv) in each case are based on the nonaqueous components of the core; and
B) have at least one hydrophobic coating arranged on the surface of the core, which coating comprises at least 70% by weight, in particular at least 80%, and especially at least 90%, based on the weight of the coating, of saturated fatty acids, the esters of saturated fatty acids, or mixtures thereof.

The weight ratio of core to coating is generally in the range from 70:30 to 99:1, preferably in the range from 75:25 to 98:2, in particular in the range from 80:20 to 96:4, and especially in the range from 85:15 to 95:5.

The inventive enzyme granules typically have particle sizes (particle diameters) which substantially correspond to those of the raw granules, that is the ratio of median particle diameter of the inventive granules to the median particle diameter of the raw granules will generally not exceed a value of 1.1:1, and in particular a value of 1.09:1. Correspondingly, the inventive enzyme granules advantageously have a median particle size in the range from 100 to 2000 μm, in particular in the range from 200 to 1500 μm, and especially in the range from 300 to 1000 μm. The geometry of the granule particles is generally cylindrical having a ratio of diameter to length of about 1:1.3 to 1:3 and having rounded ends, if appropriate.

Particularly preferred enzyme granules comprise, as enzyme, at least one phosphatase, and in particular one of the abovementioned phytases.

Phytase-comprising enzyme granules preferably have a phytase activity in the range from 1×10³ to 1×10⁵ FTU, in particular 5×10³ to 5×10⁴ FTU, and especially 1×10⁴ to 3×10⁴ FTU. 1 FTU of phytase activity is defined here as the amount of enzyme which releases 1 micromol of inorganic phosphate per minute from 0.0051 mol/l aqueous sodium phytate at pH 5.5 and 37° C. The phytase activity can be determined, for example, according to “Determination of Phytase Activity in Feed by a Colorimetric Enzymatic Method”: Collaborative Interlaboratory Study Engelen et al.: Journal of AOAC International Vol. 84, No. 3, 2001, or else Simple and Rapid Determination of Phytase Activity, Engelen et al., Journal of AOAC International, Vol. 77, No. 3, 1994.

Enzyme granules which comprise an enzyme breaking down plant cell walls, for example a xylanase, typically have an enzyme activity in the range from 300 to 500 000 EXU/g, preferably 1000 to 250 000 EXU/g, in particular 1500 to 100 000 EXU/g, particularly preferably 2000 to 80 000 EXU/g, and especially 3000 to 70 000 EXU/g.

Enzyme granules which comprise a cellulase, for example a glucanase such a a β-glucanase, typically have an enzyme activity in the range from 100 to 150 000 BGU/g, preferably 500 to 100 000 BGU/g, in particular 750 to 50 000 BGU/g, particularly preferably 1000 to 10 000 BGU/g, and especially 1500 to 8000 BGU/g.

One endo-xylanase activity (EXU) is defined as the amount of enzyme which releases 1.00 micromols of reducing sugar measured as xylose-equivalents per minute at pH 3.5 and 40° C. One beta-glucanase unit (BGU) is defined as the amount of enzyme which releases 0.258 micromols of reducing sugar measured as glucose equivalent per minute at pH 3.5 and 40° C. The endo-xylanase activity (EXU) and the β-glucanase activity (BGU) can be determined in accordance with Engelen et al.: Journal of AOAC International Vol. 79, No. 5, 1019 (1996).

The invention further relates to feed compositions, in particular pelleted feed compositions which, in addition to customary components, comprise at least one feed additive in accordance with the above definition as admixture.

Finally, the invention also relates to the use of a feed additive according to the above definition for producing feed compositions, in particular hydrothermally treated, and especially pelleted, feed compositions.

For production of the feed compositions, the coated enzyme granules produced according to the invention are mixed with conventional animal feed (such as, for example, pig-fattening feed, piglet feed, sow feed, broiler feed and turkey feed). The enzyme granule fraction is selected in such a way that the enzyme content is, for example, in the range from 10 to 1000 ppm. Subsequently, the feed is pelleted using a suitable pellet press. For this the feed mixture is customarily conditioned by steam introduction and subsequently pressed through a matrix. Depending on the matrix, pellets of about 2 to 8 mm in diameter can be produced in this way. The highest process temperature occurs in this case during conditioning or during pressing of the mixture through the matrix. Here, temperatures in the range from about 60 to 100° C. can be reached.

### EXAMPLE 1

a) In an aqueous phytase concentrate having a dry mass content of about 25 to 35% by weight, a pH in the range of 3.7-3.9 and an activity of 26 000 to 36 000 FTU/g, 1% by weight of zinc sulfate hexahydrate, based on the concentrate, was dissolved at 4-10° C.
b) In a mixer having a chopper blade, 900 g of corn starch were charged, homogenized and to this were added slowly at temperatures of 10 to 30° C. with homogenization simultaneously 380 g of the zinc sulfate-comprising phytase concentrate and 140 g of a 10% strength by weight solution of polyvinyl alcohol (degree of hydrolysis: 87-89%). The mixture was homogenized with cooling of the mixer for a further 5 min at temperatures in the range from 10 to 50° C., then the resultant dough was transferred to a dome extruder and the dough was extruded at temperatures in the range from 30 to 50° C. through a matrix having an orifice diameter of 0.7 mm to give 5 cm long strands.
c) The resultant extrudate was rounded in a rounding machine (type P50, from Glatt) for 5 min. at 350 min⁻¹ (speed of rotation of the rotating disk) and then dried to a residual moisture of about 6% by weight in a fluidized-bed dryer at a temperature of up to 40° C. (product temperature).

The resultant raw granules had an activity of approximately 14 200 FTU/g. The granules had a particle size of a maximum of 1300 μm and median particle size of 650 μm (sieve analysis).
d) For the subsequent coating, the raw granules were charged into a laboratory fluidized bed Aeromat type MP-1 from Niro-Aeromatic. As receiving vessel, use was made of a plastic cone having a gas-distribution plate diameter of 110 mm and a perforated plate having 12% open area. The coating agent was a commercially available triglyceride based on saturated C₁₆/C₁₈ fatty acids (melting point 57-61° C., iodine value 0.35, saponificaton value 192).

The raw granules (700 g) charged into the fluidized bed were heated to a product temperature of 45° C. with swirling using an air rate of 50 m³/h. 124 g of the triglyceride were melted in a glass beaker at 85° C. and sprayed onto the raw granules by means of a two-fluid nozzle (1 mm) in the bottom-spray method by reduced-pressure suction at 1 bar spraying pressure using heated spraying gas from 80 to 90° C. During spraying, the coating material and the intake line were heated to 80 to 90° C. in order to obtain a fine spray mist so that an even coating layer formed around the particles and completely enveloped them. During the spray process, the air rate was increased to 60 m³/h, in order to maintain the fluidized-bed height. The spray time was 15 min, the product temperature being 45 to 48° C. and the feed air temperature approximately 45° C. Subsequently, the product was cooled with swirling to 30° C. at 50 m³/h feed air.

A product was obtained having the following characteristic data:

### Composition:

| | | |
|---|---|---|
| Corn starch | 68.0% | by weight |
| Phytase (dry mass) | 12.0% | by weight |
| Polyvinyl alcohol: | 1.1% | by weight |
| Zinc sulfate (ZnSO₄): | 0.4% | by weight |
| Triglyceride: | 15.0% | by weight |
| Residual moisture: | 3.5% | by weight |

| | |
|---|---|
| Phytase activity: | approximately 11 800 FTU/g |
| Appearance (microscope): | particles having a smooth surface |

### COMPARATIVE EXAMPLE C1

Analogously to the protocol of example 1, steps a) to c), raw granules were produced. The resultant raw granules had a phytase activity of approximately 13 000 FTU/g and were subsequently sprayed in the fluidized-bed apparatus according to example 1 step d) with a commercially available aqueous polyethylene dispersion (solids content 30% by weight, viscosity: 50-300 mPas, pH 9.5-11.5)

For this, the raw granules (700 g) were swirled at room temperature at a feed air rate of 35 m³/h. The polyethylene dispersion was sprayed onto the enzyme granules using a two-fluid nozzle (1.2 mm) at a feed air temperature of 35° C., feed air rate of 45 m³/h, at 1.5 bar by pumping using a peristaltic pump. The product temperature during spraying was 30 to 50° C. The dispersion was sprayed onto the enzyme granules in the top-spray method. In this method the water of the dispersion evaporated and the PE particles surrounded the granule particles and stuck to their surface (coating). During spraying, the feed air rate was increased stepwise to 65 m³/h to maintain swirling. The spraying time was 15 min. Subsequently, the product was dried for 30 min at product temperature 30 to 45° C., the feed air rate being lowered to 55 m³/h, in order to keep abrasion of the coating as low as possible.

A product was obtained having the following characteristic data:

### Composition:

| | | |
|---|---|---|
| Corn starch | 78.6% | by weight |
| Phytase (dry mass) | 12.0% | by weight |
| Polyvinyl alcohol: | 1.4% | by weight |
| Zinc sulfate (ZnSO₄): | 0.5% | by weight |
| Polyethylene: | 4.0% | by weight |
| Residual moisture: | 3.5% | by weight |

| | |
|---|---|
| Phytase activity: | approximately 12 530 FTU/g |
| Appearance (microscope): | particles having a smooth surface |

### EXAMPLE 2

a) In an aqueous phytase concentrate having a dry mass content of about 25-35% by weight, a pH in the range of 3.7-3.9 and an activity of 26 000-36 000 FTU/g, 1% by weight of zinc sulfate hexahydrate, based on the concentrate, was dissolved at 4-10° C. Subsequently, a pH of 5 was set by adding 5% by weight, based on the phytase concentrate, of a 5% strength by weight aqueous ammonia solution.
b)+c) Using the neutralized phytase concentrate produced in a), rounded raw granules were produced according to the protocol of example 1 steps b) and c).

The resultant raw granules had an activity of approximately 13 300 FTU/g. The granules had a particle size of a maximum of 1300 μm and a median particle size of 645 μm (sieve analysis).
d) The resultant raw granules were then coated according to the protocol of example 1, step d) in a laboratory fluidized bed Aeromat type MP-1 from Niro-Aeromatic. The coating agent was a commercially available triglyceride based on saturated C₁₆/C₁₈-fatty acids (melting point 57-61° C., iodine value 0.35, saponification value 192).

A product was obtained having the following characteristic data:

### Composition:

| | | |
|---|---|---|
| Corn starch | 68.0% | by weight |
| Phytase (dry mass) | 12.0% | by weight |
| Polyvinyl alcohol: | 1.1% | by weight |
| Zinc sulfate (ZnSO₄): | 0.4% | by weight |
| Triglyceride: | 15.0% | by weight |
| Residual moisture: | 3.5% | by weight |

| | |
|---|---|
| Phytase activity: | approximately 11 050 FTU/g |
| Appearance (microscope): | particles having a smooth surface |

### EXAMPLE 3

a) In an aqueous phytase concentrate having a dry mass content of about 25-35% by weight, a pH in the range of 3.7-3.9 and an activity of 26 000-36 000 FTU/g, 1% by weight of zinc sulfate hexahydrate, based on the concentrate, was dissolved at 4-10° C. The concentrate was heated to 30° C. and 1.1% by weight of methylcellulose (molecular weight of 70 000-120 000 g/mol, viscosity: 4600 cps at 2% by weight in water and 20° C., degree of substitution 1.6-1.9) was added to this and the mixture was stirred until the methylcellulose had completely dissolved. Then, a pH of 5 was set by adding 5% by weight, based on the phytase concentrate, of a 5% strength by weight aqueous ammonia solution.
b) In a mixer having a chopper blade, 890 g of corn starch were charged, homogenized, and to this were added 433 g of the phytase concentrate from step a) slowly at temperatures of 10 to 30° C. with homogenization. The mixture was homogenized with cooling of the mixer for a further 5 min at temperatures in the range from 10 to 50° C., then the resultant dough was transferred to a dome extruder and the dough was extruded at temperatures in the range from 30 to 50° C. through a die having an orifice diameter of 0.7 mm to give 5 cm long strands.
c) The resultant extrudate was rounded in a rounding machine (type P50, from Glatt) for 5 min at 350 min⁻¹ (speed of rotation of the disk) and subsequently dried in a fluidized-bed dryer at a temperature of 40° C. (product temperature) to a residual moisture of about 6% by weight.

The resultant raw granules had an activity of approximately 12 700 FTU/g. The granules had a particle size of a maximum of 1400 μm and a median particle size of 662 μm (sieve analysis).
d) The resultant raw granules were then coated in accordance with the protocol from example 1, step b) in a laboratory fluidized bed Aeromat type MP-1 from Niro-Aeromatic. The coating agent was a commercially available triglyceride based on saturated C₁₆/C₁₈-fatty acids (melting point 57-61° C., iodine value 0.35, saponification value 192).

A product was obtained having the following characteristic data:

### Composition:

| | | |
|---|---|---|
| Corn starch | 68.6% | by weight |
| Phytase (dry mass) | 12.0% | by weight |
| Methylcellulose: | 0.5% | by weight |
| Zinc sulfate (ZnSO₄): | 0.4% | by weight |
| Triglyceride: | 15.0% | by weight |
| Residual moisture: | 3.5% | by weight |

| | |
|---|---|
| Phytase activity: | approximately 10 450 FTU/g |
| Appearance (microscope): | Particles having a smooth surface |

### EXAMPLE 4

Production was performed in a similar manner to example 3, but in contrast to the protocol specified there, no aqueous ammonia solution was added.

A product having the following characteristic data was obtained:

### Composition:

| | | |
|---|---|---|
| Corn starch | 68.6% | by weight |
| Phytase (dry mass) | 12.0% | by weight |
| Methylcellulose: | 0.5% | by weight |
| Zinc sulfate (ZnSO₄): | 0.4% | by weight |
| Triglyceride: | 15.0% | by weight |
| Residual moisture: | 3.5% | by weight |

| | |
|---|---|
| Phytase activity: | approximately 10 760 FTU/g |
| Appearance (microscope): | Particles having a smooth surface |

### Experiment 1: Determination of Pelleting Stability

To assess the pelleting stability of the above-described enzyme granules, a standard pelleting was established. For this, to improve the analytical content determinations, the dosage in the feed was increased. The pelleting was carried out in such a manner that a conditioning temperature of 80 to 85° C. was achieved. Representative samples of the feed before and after pelleting were obtained. The enzyme activity was determined in these samples. If appropriate after correcting for the content of enzyme which is present in the native state, the losses due to pelleting and the relative residual activity (=retention) can be calculated.

The analytical method for phytase is described in various publications: Simple and Rapid Determination of Phytase Activity, Engelen et al., Journal of AOAC International, Vol. 77, No. 3, 1994; Phytase Activity, General Tests and Assays, Food Chemicals Codex (FCC), IV, 1996, p. 808-810; Bestimmung der Phytaseaktivität in Enzymstandardmaterialien und Enzympräparaten [Determination of phytase activity in standard enzyme materials and enzyme preparations] VDLUFA-Methodenbuch [Handbook of Methods of the German Association of Agricultural Analytical and Research Institutes], Volume III, 4th supplement 1997; or Bestimmung der Phytaseaktivität in Futtermitteln und Vormischungen [Determination of phytase activity in feeds and premixes] VDLUFA-Methodenbuch, Volume III, 4th supplement 1997.

As feed, use was made of a commercially available broiler feed having the following composition:

| | |
|---|---|
| Corn | 45.5% |
| Soybean extraction meal | 27.0% |
| Full-fat soybeans | 10.0% |
| Peas | 5.0% |
| Tapioca | 4.7% |
| Soybean oil | 3.5% |
| Lime | 1.35% |
| Monocalcium phosphate | 1.30% |
| Cattle salt | 0.35% |
| Vitamin/trace element premix | 1.00% |
| D,L-Methionine | 0.25% |
| L-Lysine HCl | 0.05% |
| | 100% |

The coated granules produced in the above examples were mixed with the above standard feed (content 500 ppm), pelleted and the samples obtained were analyzed. The relative improvement in retention of enzyme activity compared with the granules from comparative example C1 was calculated as follows: Ratio of retention of enzyme activity of the improved granules to retention of enzyme activity of the granules from comparative example C1. The results are summarized in table 1 hereinafter.

TABLE 1
Pelleting stability achieved

| | Description of the granules | Relative pelleting stability |
|---|---|---|
| No. | (coating, binder, pH) | [%] |
| Comparative | 4% PE, 1.4% PVA, pH 3.9 | 100 |
| example C1 | | |
| Example 1 | 15% fat, 1.1% PVA, pH 3.9 | 118 |
| Example 2 | 15% fat, 1.1% PVA, pH 5 | 142 |
| Example 3 | 15% fat, 0.5% MC, pH 5 | 147 |
| Example 4 | 15% fat, 0.5% MC, pH 3.9 | 133 |

PE = Polyethylene
PVA = Polyvinyl alcohol
MC = Methylcellulose

1. A method for producing solid enzyme granules for feeds which comprises the following steps:
a) extruding an enzyme-comprising dough which, in addition to water, comprises
i) 50 to 96.9% by weight of at least one solid carrier material suitable for feed,
ii) 0.1 to 20% by weight of at least one water-soluble polymeric binder,
iii) 3 to 49.9% by weight of at least one enzyme,
the weight fractions of i), ii) and iii) in each case being based on the nonaqueous components of the dough;
b) final-processing the extrudate to give raw granules having a water content of no greater than 15% by weight, and
c) coating the raw granules with a hydrophobic material, selected in an extent of at least 70% by weight, based on the hydrophobic material, from saturated fatty acids, the esters of saturated fatty acids, and mixtures thereof.

2. The method according to claim 1, wherein in step c), the raw granules are coated with the hydrophobic material in an amount of 1 to 30% by weight, based on the nonaqueous components of the raw granules.

3. The method according to claim 1, wherein in step c), the hydrophobic material being used is in the form of its melt.

4. The method according to claim 1, wherein the hydrophobic material comprises at least 70% by weight of one or more triglycerides.

5. The method according to claim 1, wherein in step b), the extrudate from step a) is subjected to spheronization and subsequently dried, in order to obtain raw granules having a residual water content of no greater than 15% by weight, based on the total weight of the raw granules.

6. The method according to claim 1, wherein the raw granules obtained in step b) have a median particle size in the range from 100 to 2000 μm.

7. The method according to claim 1, wherein the carrier material comprises at least one water-insoluble polymeric carbohydrate.

8. The method according to claim 1, wherein the water-soluble polymeric binder is selected from polyvinyl alcohol or water-soluble polysaccharides.

9. The method according to claim 8, wherein the water-soluble polymeric binder is methylcellulose.

10. The method according to claim 1, wherein the enzyme is a phosphatase [E.C. 3.1.3].

11. The method according to claim 1, wherein the dough used in step a) additionally comprises a salt stabilizing the enzyme in an amount of 0.1 to 10% by weight, based on the total weight of all nonaqueous components of the dough.

12. The method according to claim 11, wherein the salt is selected from zinc sulfate or magnesium sulfate.

13. Enzyme granules for feeds obtained by the method according to 1.

14. An enzyme granule for feeds, comprising one or more particles which comprise
A) an enzyme-comprising core having a water content less than 15% by weight, based on the weight of the enzyme-comprising core which comprises
i) 50 to 96.9% by weight of at least one solid carrier material suitable for feeds,
ii) 0.1 to 20% by weight of at least one water-soluble polymeric binder,
iii) 3 to 49.9% by weight of at least one enzyme,
the weight fractions of i), ii) and iii) in each case being based on the nonaqueous components of the core; and
B) at least one hydrophobic coating arranged on the surface of the core, which coating comprises at least 70% by weight, based on the weight of the coating, of saturated fatty acids, the esters of saturated fatty acids, or mixtures thereof.

15. The enzyme granule according to claim 14, wherein the weight ratio of core to coating is in the range from 70:30 to 99:1.

16. The enzyme granule according to claim 14, wherein the hydrophobic coating comprises at least 70% by weight of one or more triglycerides.

17. The enzyme granule according to claim 14 which has a median particle size in the range from 100 to 2000 μm.

18. The enzyme granule according to 14, wherein the carrier material comprises at least one water-insoluble polymeric carbohydrate.

19. The enzyme granule according to claim 14, wherein the water-soluble polymeric binder is selected from polyvinyl alcohol and water-soluble polysaccharides.

20. The enzyme granule according to claim 19, wherein the water-soluble polymeric binder is methylcellulose.

21. The enzyme granule according to 14, wherein the enzyme is a phosphatase [E.C.3.1.3].

22. The enzyme granule according to 14, wherein the core additionally comprises a salt stabilizing the enzyme in an amount of 0.1 to 10% by weight, based on the total weight of all nonaqueous components of the core.

23. The enzyme granule according to claim 22, wherein the salt is selected from zinc sulfate or magnesium sulfate.

24. A method of producing feed comprising utilizing the enzyme granule according to claim 13 in feeds.

25. A feed comprising at least one enzyme granule according to claim 13 and customary feed components.

26. The feed according to claim 25 in the form of a pelleted feed.

27. The method of claim 1, wherein the enzyme is a phytase.

28. The enzyme granule of claim 14, wherein the enzyme is a phytase.
